(19) United States
(12) Patent Application Publication
(10) Pub. No.: US 2011/0137819 A1
(43) Pub. Date: Jun. 9, 2011

(54) TOOL FOR CREATING AN INDUSTRY BUSINESS ARCHITECTURE MODEL

(75) Inventors: Muthulakshmi Bhandari, Bangalore (IN); Allison Baines Botros, Independence, OH (US); Edward H B Giesen, Bilthoven (NL); Raman Harishankar, Blacklick, OH (US); Jayashree Jaishankar, Bangalore (IN); Ahamed Jalaldeen, Bangalore (IN); Ying Tat Leung, Saratoga, CA (US); Ashish Mungi, Bangalore (IN); Siddharth N. Purohit, Allen, TX (US); Philip G. Rains, Naperville, IL (US); Jorge L. C. Sanz, Carmel, CA (US)

(73) Assignee: INTERNATIONAL BUSINESS MACHINES CORPORATION, Armonk, NY (US)

(21) Appl. No.: 12/631,092

(22) Filed: Dec. 4, 2009

(51) Int. Cl. G06Q 10/00; G06F 15/16

(52) U.S. Cl. 705/348; 709/203

(57) ABSTRACT

A system creates and maintains an industry business architecture model (IBAM) over a network. The IBAM has a component business model, process model, service model, and information model. It also may include a reference architecture, demos and other knowledge assets, and collateral.

### CROSS REFERENCE TO RELATED APPLICATIONS

This present invention is related to U.S. application Ser. No. ______ filed ______ entitled SYSTEM FOR MANAGING BUSINESS PERFORMANCE USING INDUSTRY BUSINESS ARCHITECTURE MODELS, and U.S. application Ser. No. ______ filed ______ entitled ASSESSING THE MATURITY OF AN INDUSTRY ARCHITECTURE MODEL which are incorporated herein by reference in its entirety.

### BACKGROUND OF THE INVENTION

1. Field of the Invention

The invention relates generally to enterprise architectures and more particularly to a system for creating an industry business architecture model. An enterprise architecture shall be defined herein to mean a framework for coordinating many aspects of an enterprise. It is an overall plan that integrates business goals, visions, strategies, and governance principles with business operations, such as organizational structure, processes, and data. Enterprise architectures are inherently complex in nature. Assessing its ongoing vitality and effectiveness as well as redesigning or upgrading as needed presents a formidable challenge when using present techniques.

2. Description of the Related Art

Dill, in U.S. Pat. No. 7,120,643 describes a general system for creating and maintaining an enterprise architecture. His system includes forming a maturity model map with a central graphical area. The graph indicates the significance of each element compared to other component elements in the maturity model map.

Rackham in U.S. 2005/0203784 patent application describes creating a component business model. Dill and Rackham shall be incorporated herein by reference.

### BRIEF SUMMARY OF THE INVENTION

The system of the present invention is used to create and maintain an industry business architecture model (IBAM) having the logical models: component business model, process model, service model, and information model. The system comprises at least one client system; a server coupled to the client over a network; a data storage device in communication with the server via the network; and an industry business architecture model executing on the server or client or a combination of the above.

### BRIEF DESCRIPTION OF THE SEVERAL VIEWS OF THE DRAWINGS

FIG. 1 is a flowchart for creating an IBAM;

FIG. 2 is a flowchart for creating or updating a component business model;

FIG. 3 is a flowchart for creating or updating a process model;

FIG. 4 is a flowchart for creating or updating a service model;

FIG. 5 is a flowchart for creating or updating the data model part of an information model;

FIG. 6 is a flowchart for creating or updating the message model part of an information model;

FIG. 7 is a flowchart for creating or updating the business terms/glossary part of an information model; and

FIG. 8 is a flowchart for creating a listing of knowledge assets and collateral for use in an IBAM.

### DETAILED DESCRIPTION OF THE INVENTION

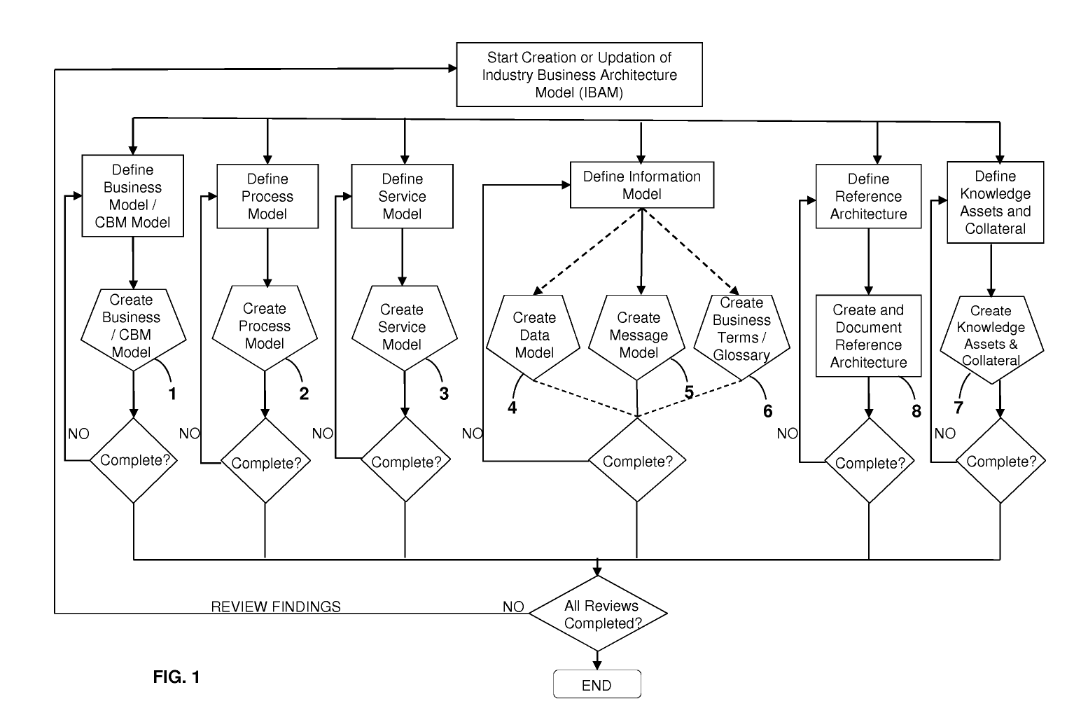

In FIG. 1 there is shown a flowchart for creating or updating an IBAM. It is readily apparent that each path may be performed separately. For example, the Business/CBM model may be created or updated at any time, regardless of the status of other models.

The information model has three parts, Data Model 4, Message Model 5, and Business Terms/Glossary 6, which may also be created or updated at any time. Reference architecture 8, and Knowledge Assets and Collateral 7 can also be created or updated at any time.

Note, however, that from FIG. 1, all 6 paths must be completed before the IBAM is completed.

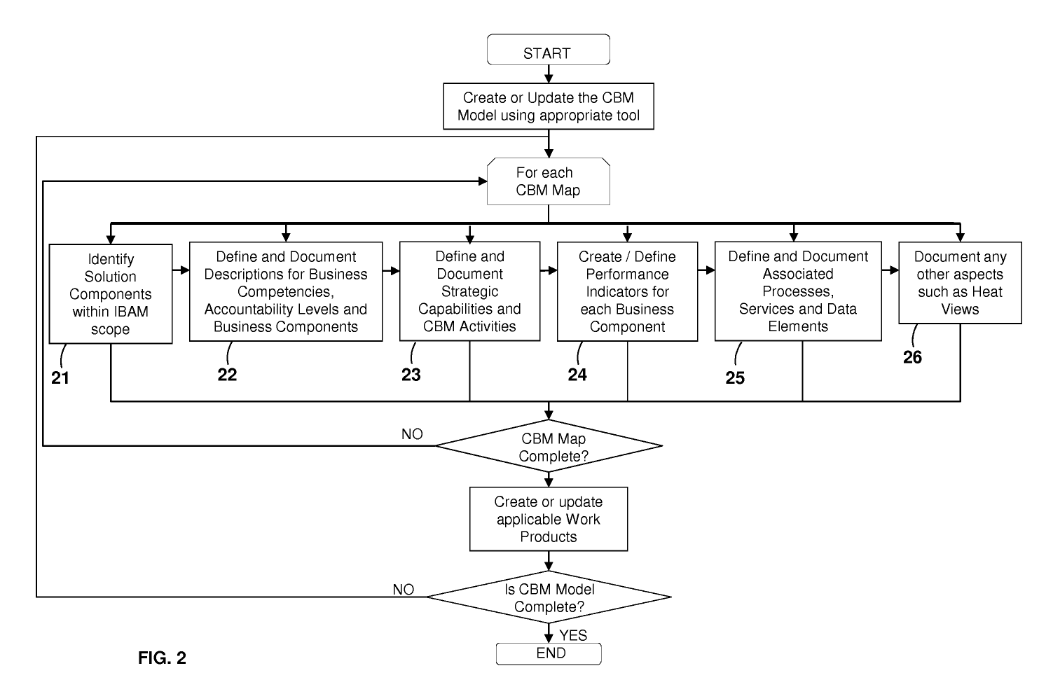

In FIG. 2 there is shown a flowchart for creating or updating a CBM model. Solution components are identified in step 21. Business competencies, accountability levels, and business components are defined in step 22. In step 23, strategic capabilities and CBM activities are defined.

Performance indicators also referred to as key performance indicators (KPIs) for each component are defined in step 24. Associated processes, services, and data elements are defined in step 25. This may include defining linkages to other models in the IBAM such as linkages to elements or steps in the process model, service model, or information model.

In step 26, other aspects of the CBM model including a heat map, are defined.

Alternatively, the CBM model may be created using the steps described in Rackham U.S. 2005/0203784.

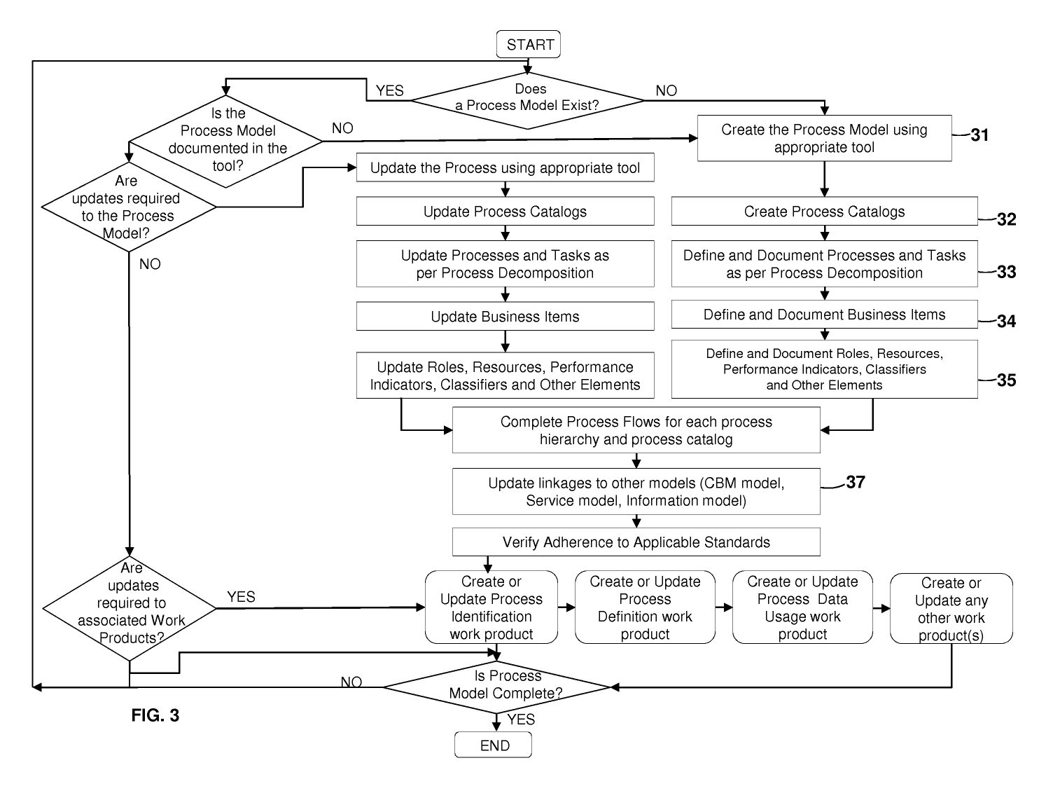

In FIG. 3 there is shown a flow diagram for creating or updating a process model. The most important steps in creating a process model 31-37 will be described. It will be obvious to one of ordinary skill how to update a process model, or any other model, therefore updating steps in the flowchart are not specifically described herein. In step 31 a process model is created using the tool of the present invention. In step 32 process catalogs are created. In step 33 processes and tasks resulting from process decomposition are defined. Business items are defined in step 34. Roles, resources, performance indicators, and classifiers are defined in step 35.

In step 37 linkages to other models including the CBM model, service model, and information model are defined or updated.

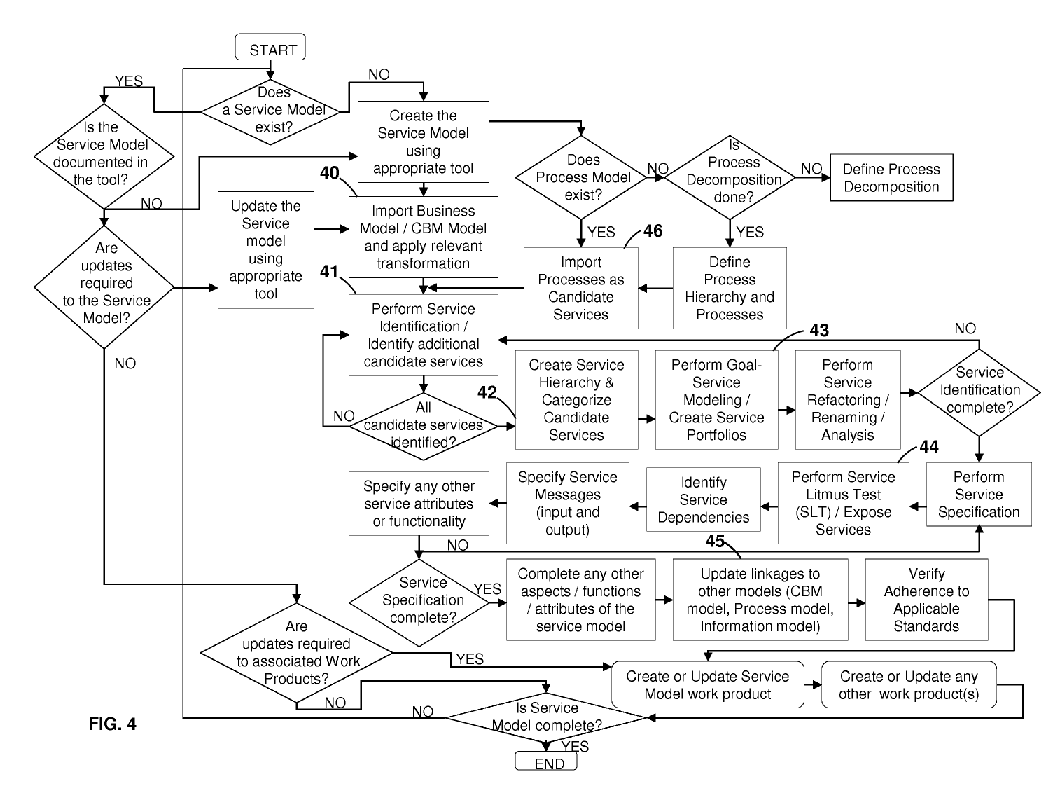

In FIG. 4 there is shown a flowchart for creating or updating a service model in accordance with the present invention. The CBM model is imported 40 and processes from the process model described above are imported 46.

Services are identified in step 41. A service hierarchy is created in step 42. In step 43, goal service modeling is performed to create service portfolios. Goal service modeling is described by Ang in U.S. patent application Ser. No. 11/496917 filed Jul. 31, 2006 and published as U.S. 2008/0027784 on Jan. 31, 2008.In step 44 a service litmus test (SLT) is performed to expose services. Ang describes SLT in U.S. patent application Ser. No. 11/496,893 filed Jul. 31, 2006 and published as U.S. 2008/0126147 on May 29, 2008. Both applications by Ang shall be incorporated herein by reference in their entireties.

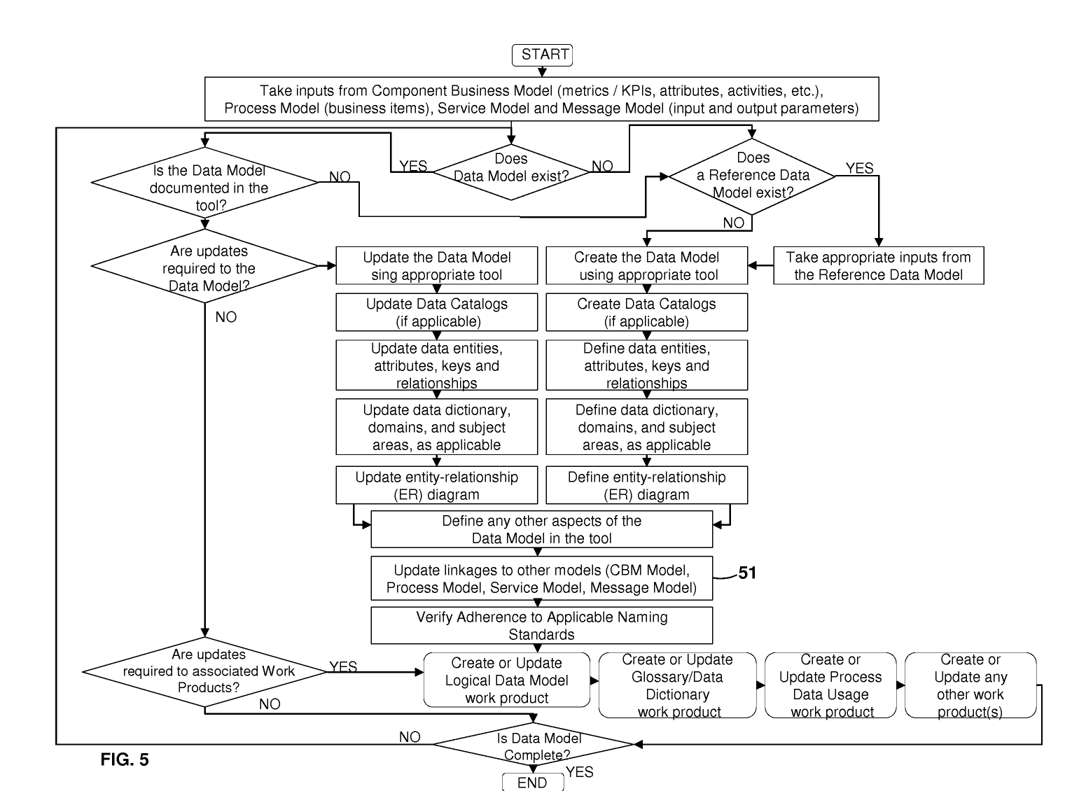

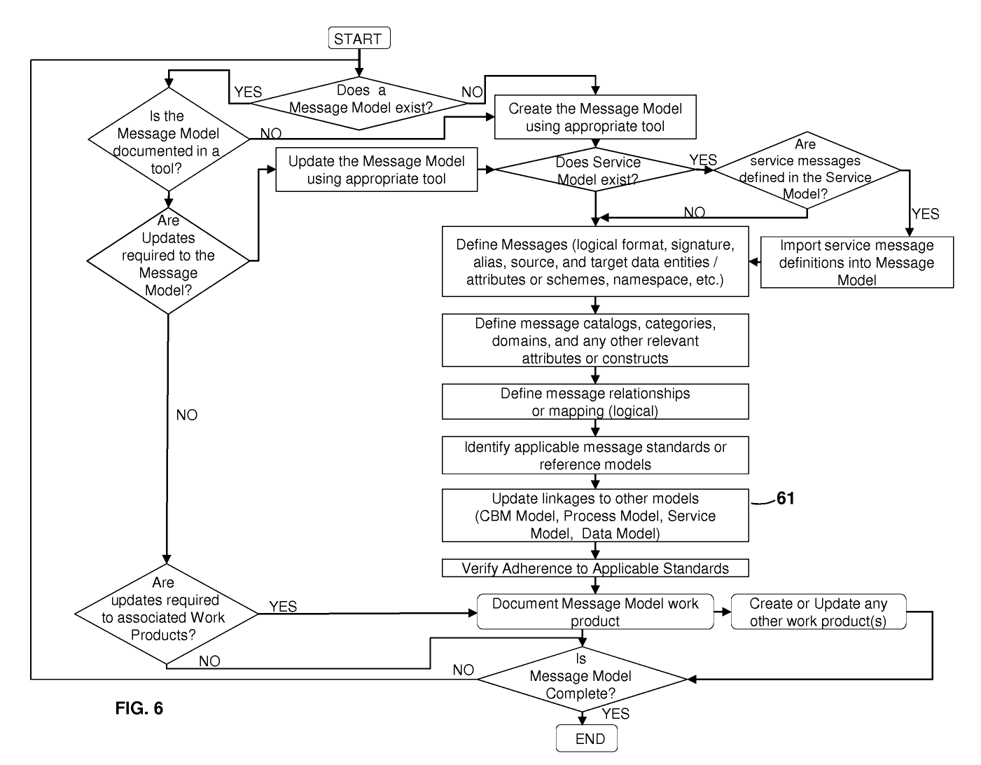

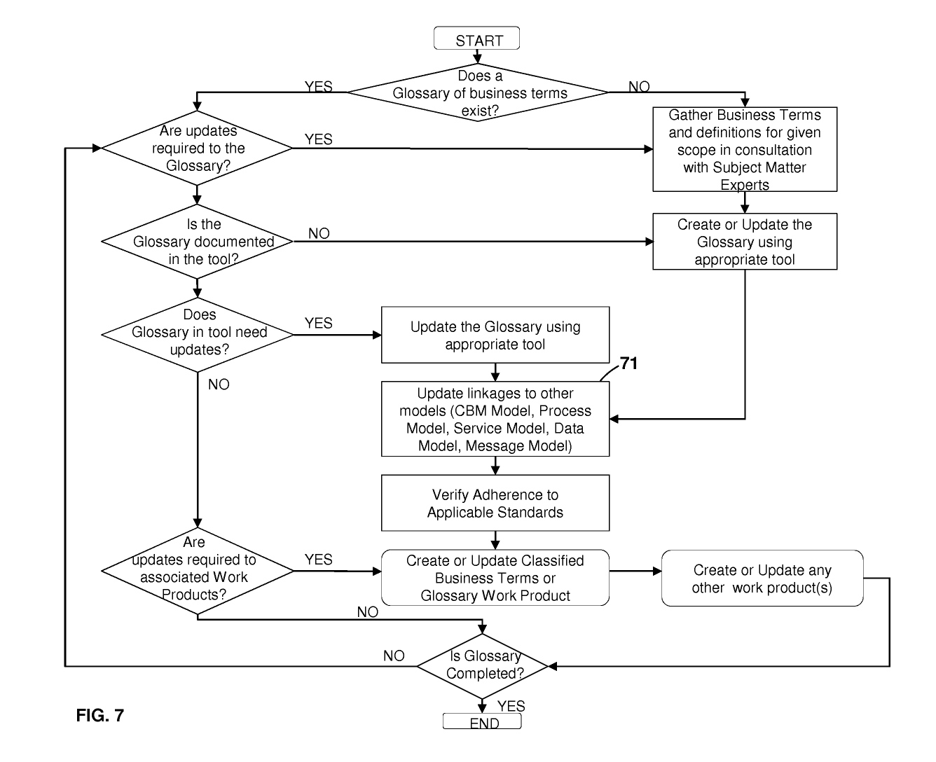

In FIGS. 4, 5, 6, and 7 there are shown flowcharts for creating the data model, message model, and glossary of business terms, of an information model, respectively. It is important to note that each flowchart includes a step, 45, 51, 61, and 71 respectively for creating linkages to other models in the IBAM, specifically CBM model, process model, and service model.

Although according to FIG. 1 the various IBAM models can be created or updated at any time, the various linkages tie each model to the others providing cohesion to the IBAM.

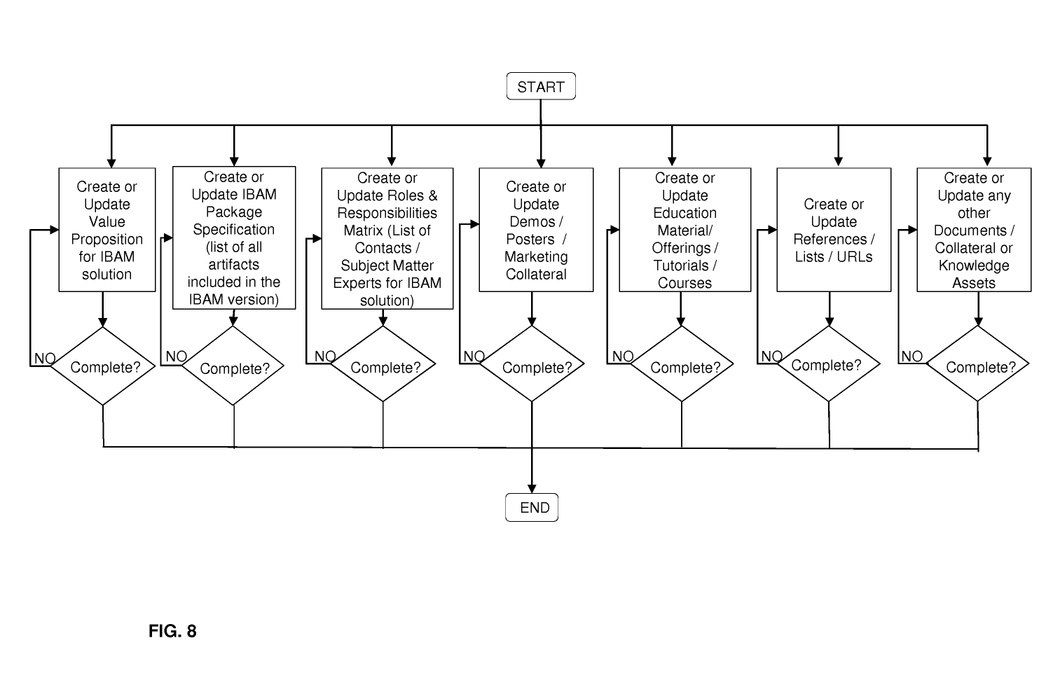

In FIG. 8 there is shown a flowchart for creating or updating additional parts of the IBAM. These include a value proposition, a package specification, roles and responsibilities matrix, demos, education material, references, and knowledge assets. Each of these can be created or updated at any time as shown in FIG. 8.

While there have been shown and described what are at present considered the preferred embodiments of the invention, it will be obvious to those skilled in the art that various changes and modification may be made therein without departing from the scope of the invention as defined by the appended claims.

What is claimed is:

1. A system for creating an industry business architecture model over a network, comprising:
at least one client system;
a server operably coupled to said at least one client system via said network;
a plurality of applications executable via said server;
a data storage device in communication with said server via said network, the data storage device storing databases housing information and models resulting from execution of said plurality of applications, the databases including a component business model database, a process model database, a service model database, and an information model database;
an industry business architecture model executing on said system, said industry business architecture model performing:
creating a CBM model, a process model, a services model, and an information model, and linkages therebetween;
creating a reference architecture and defining knowledge assets; and
storing said models, said reference architecture, and said knowledge assets in said data storage device.

2. The system of claim 1, wherein said component business model includes at least one heat map.

3. The system of claim 1, wherein said component business model includes key performance indicators.

4. The system of claim 3, further comprising a data collection device for collecting cost center data from an enterprise and calculating values for said key performance indicators.

5. The system of claim 1, wherein said services model includes service portfolios created by performing goal service modeling.

6. The system of claim 1, wherein said services model includes services exposed by performing a services litmus test.

7. A storage medium encoded with machine-readable computer program code for creating an industry business architecture model over a network to implement a method, comprising:
executing a plurality of applications on a server;
storing databases on a data storage device in communication with said server over said network, said databases housing information and models resulting from execution of said plurality of applications, the databases including a component business model database, a process model database, a service model database, and an information model database;
executing on said system, an industry business architecture model, said industry business architecture model performing:
creating a CBM model, a process model, a services model, and an information model, and linkages therebetween;
creating a reference architecture and defining knowledge assets; and
storing said models, said reference architecture, and said knowledge assets in said data storage device.

8. The storage medium of claim 7, further comprising instructions for causing said network to implement collecting cost center data from an enterprise using a data collection device operably coupled to said network, and calculating values for key performance indicators in said component business model using said cost center data.
